(19) United States
(12) Patent Application Publication
(10) Pub. No.: US 2026/0099739 A1
(43) Pub. Date: Apr. 9, 2026

(54) Computer System, Information Processing Method, and Non-transitory Computer-Readable Storage Medium

(71) Applicant: Hitachi, Ltd., Tokyo (JP)

(72) Inventors: Yoshimi NOGUCHI, Tokyo (JP); Naoko SENDA, Tokyo (JP)

(21) Appl. No.: 19/284,823

(22) Filed: Jul. 30, 2025

(30) Foreign Application Priority Data
Oct. 7, 2024 (JP) 2024-175635

(51) Int. Cl. G06N 7/01

(52) U.S. Cl. CPC G06N 7/01

(57) ABSTRACT

A computer system stores a data set constituted with measurement data including measurement results of intensities of a plurality types of signals of particles contained in a sample measured using a flow cytometry, and a machine learning model configured to receive, as an input, a feature value of a first region generated by dividing an observation space using intensities of two or more types of signals as parameters based on a distribution feature of the measurement data in the observation space, and configured to output a probability of a class to which each coordinate of the observation space belongs. The computer system maps the measurement data into the observation space, divides the observation space into a plurality of the regions based on the distribution feature of the measurement data in the observation space, calculates a feature value of each region, inputs the feature value of each region into the machine learning model, and sets a gate based on the probability of the class to which each coordinate in the observation space belongs, which is output from the model.

### CROSS-REFERENCE TO RELATED APPLICATIONS

This application claims the benefit of and priority to Japanese Patent Application No. 2024-175635 filed on October 7, 2024, and the content thereof is incorporated herein by reference in its entirety.

### BACKGROUND OF THE INVENTION

### 1. Field of the Invention

The present invention relates to gating in data analysis of flow cytometry.

### 2. Description of Related Art

Lesions are increasingly being examined using flow cytometry. In data analysis of flow cytometry, gating for classifying particles into common groups under any condition based on measurement results is important. In gating, a gate serving as a boundary of a group is set. For example, PTL 1 is known as a technique related to gating.

PTL 1 discloses that "this method includes generating an image for each of first and second sets of flow cytometer data. In some examples, generating the image includes organizing data into two-dimensional bins and assigning a shadow to each bin so that the bin is represented by a pixel. In some examples, the method includes warping the generated image of the first set of flow cytometer data with a computer-implemented algorithm to maximize the similarity of the flow cytometer data to the second set, and applying the same conversion to the training gate. In some embodiments, this method includes overlaying the adjusted training gate on the generated image of the second set of flow cytometer data. A system and a computer-readable medium for adjusting a training gate are also provided".

### Citation List

### Patent Literature

PTL 1: JP2023-511761A

### SUMMARY OF THE INVENTION

In gating in the related art, a clustering method is adopted. In clustering, data is classified into groups based on the similarity between data in a feature value space (observation space). In the case of this method, in a region where data is not concentrated, the data in the region may not be classified into any group. In examinations of lesions, analysis of a region where data is not concentrated may be important. Therefore, analysis may be difficult in gating in the related art.

Similar issues also exist with respect to gating by parameter discriminant analysis and threshold optimization.

An object of the invention is to provide a method capable of setting a gate even in a region where data in an observation space is sparse.

A representative example of the invention disclosed in the present application is as follows. That is, a computer system includes: a processor; and a storage device connected to the processor, in which the storage device stores a data set constituted with measurement data including measurement results of intensities of a plurality types of signals of particles contained in a sample measured using a flow cytometry, and a machine learning model configured to receive, as an input, a feature value of a first region generated by dividing an observation space using intensities of two or more types of signals as parameters based on a distribution feature of the measurement data in the observation space, and configured to output a probability of a class to which each coordinate of the observation space belongs, and the processor maps a plurality of pieces of the measurement data into an observation space using an intensity of a signal of a type selected by a user, divides the observation space into a plurality of the first regions based on the distribution feature of the measurement data in the observation space, calculates the feature value of each of the plurality of first regions, inputs the feature value of each of the plurality of first regions into the machine learning model, and sets a gate based on the probability of the class to which each coordinate in the observation space belongs, which is output from the machine learning model.

According to the invention, a gate can be set even in a region where measurement data is sparse. Problems, configurations, and effects other than those described above will be clarified by the description of the following embodiments.

### BRIEF DESCRIPTION OF THE DRAWINGS

FIG. 1 is a diagram illustrating a configuration example of a system according to Embodiment 1;

FIG. 2 is a diagram illustrating an example of a functional configuration of a computer according to Embodiment 1;

FIG. 3A is a diagram illustrating an example of a measurement data database according to Embodiment 1;

FIG. 3B is a diagram illustrating an example of the measurement data database according to Embodiment 1;

FIG. 4 is a diagram illustrating an example of a model database according to Embodiment 1;

FIG. 5 is a diagram illustrating an example of a setting information database according to Embodiment 1;

FIG. 6 is a flowchart illustrating an example of analysis processing executed by the computer according to Embodiment 1;

FIG. 7 is a diagram illustrating an example of division of an observation space executed by the computer according to Embodiment 1;

FIG. 8 is a diagram illustrating an example of information stored by the computer according to Embodiment 1;

FIG. 9 is a diagram illustrating an example of a screen presented by the computer according to Embodiment 1;

FIG. 10 is a diagram illustrating an example of a functional configuration of a computer according to Embodiment 2; and

FIG. 11 is a flowchart illustrating an example of analysis processing executed by the computer according to Embodiment 2.

### DESCRIPTION OF EMBODIMENTS

Hereinafter, embodiments of the invention will be described with reference to the drawings. However, the invention is not to be construed as being limited to the description of the following embodiments. It will be easily understood by those skilled in the art that a specific configuration can be changed without departing from the spirit or scope of the invention.

In configurations of the invention to be described below, the same or similar configurations or functions are denoted by the same reference numerals, and redundant descriptions will be omitted.

Notations "first", "second", "third", and the like in the present specification are provided to identify components and do not necessarily limit the number or the order.

To facilitate understanding of the invention, a position, a size, a shape, a range, and the like of each configuration illustrated in the drawings and the like may not represent an actual position, size, shape, range, and the like. Therefore, the invention is not limited to the positions, sizes, shapes, ranges, and the like disclosed in the drawings.

### Embodiment 1

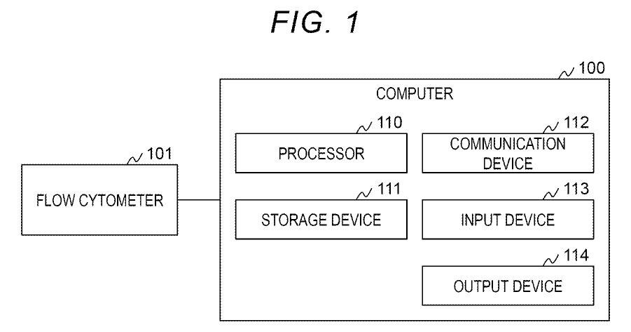

FIG. 1 is a diagram illustrating a configuration example of a system according to Embodiment 1.

The system includes a computer 100 and a flow cytometer 101. The computer 100 and the flow cytometer 101 are connected, for example, via a network such as a local area network (LAN).

The flow cytometer 101 irradiates a sample containing particles such as cells with laser light, and measures signal intensities of a plurality of types of light (measurement items) such as scattered light and fluorescent light emitted by the particles. The flow cytometer 101 inputs measurement data including a measurement result of each of the measurement items of the particles to the computer 100. That is, the same number of measurement data as the number of measured particles is input to the computer 100. Hereinafter, a plurality of pieces of measurement data is also referred to as a measurement data set.

In Embodiment 1, an examination of cells of a patient undergoing treatment for a disease will be described as an example. In this case, a specimen such as blood is a sample.

The computer 100 performs analysis using the measurement data set. The computer 100 includes a processor 110, a storage device 111, a communication device 112, an input device 113, and an output device 114. The hardware elements are connected via a bus that is not illustrated.

The processor 110 executes a program stored in the storage device 111. The processor 110 executes processing according to the program to operate as a functional unit (a module) that implements a specific function. In the following description, when the processing is described with the functional unit as a subject, it indicates that the processor 110 executes a program for implementing the functional unit.

The storage device 111 is a memory or the like, and stores the program executed by the processor 110 and information used by the program. A storage medium, such as a hard disk drive (HDD) and a solid state drive (SSD) that store a database may be included.

The communication device 112 communicates with an external device via a network. The input device 113 is a keyboard, a mouse, a touch panel, or the like. The output device 114 is a display or the like.

The computer 100 may acquire the measurement data from an external system, such as a cloud system used by a user.

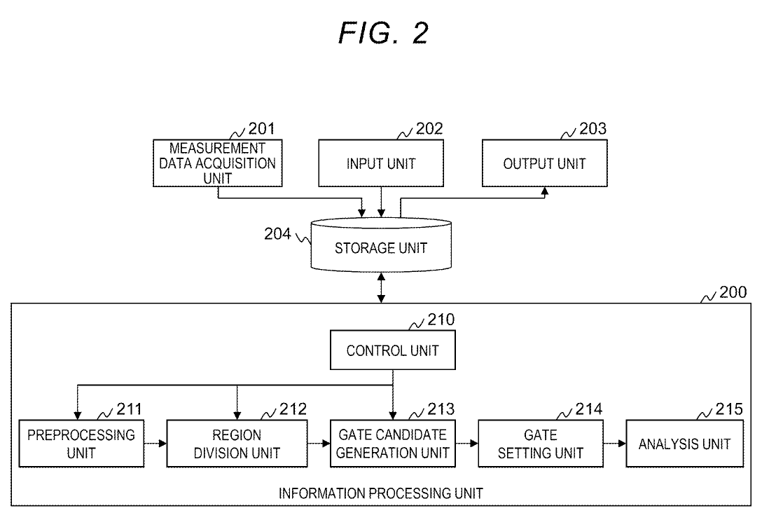

FIG. 2 is a diagram illustrating an example of a functional configuration of the computer 100 according to Embodiment 1.

The computer 100 includes an information processing unit 200, a measurement data acquisition unit 201, an input unit 202, an output unit 203, and a storage unit 204.

The measurement data acquisition unit 201 acquires the measurement data set. The input unit 202 receives various inputs to the computer 100. The output unit 203 outputs data managed by the computer 100 and data processed by the computer 100.

The storage unit 204 manages various types of data. The storage unit 204 according to Embodiment 1 manages a measurement data database that stores the measurement data set, a model database that stores a machine learning model, and a setting information database that stores analysis setting information. Each of the databases is stored in the storage device 111.

The machine learning model is, for example, a Transformer. The machine learning model receives, as an input, a feature value of a region (occupied region) generated by dividing an observation space using intensities of two or more types of signals as parameters, based on a distribution feature of the measurement data in the observation space, and outputs a probability of a class to which each coordinate in the observation space belongs.

By generating in advance a model for performing class classification of coordinates in the observation space based on the feature value of the occupied region, it is possible to set a gate with high accuracy and at high speed.

Since the number of the occupied regions is not unique, the machine learning model is assumed to be a model capable of receiving a sufficient number of inputs.

The machine learning model may receive, as an input, a new feature value calculated using the feature value of the occupied region, for example, a similarity in area or shape between the occupied regions.

The information processing unit 200 performs analysis using the measurement data set. The information processing unit 200 includes a control unit 210, a preprocessing unit 211, a region division unit 212, a gate candidate generation unit 213, a gate setting unit 214, and an analysis unit 215.

The control unit 210 inputs various types of information to other functional units. The preprocessing unit 211 executes preprocessing on the measurement data. For example, data shaping, rounding of data values, and the like are executed as the preprocessing.

The region division unit 212 generates a scatter diagram (dot plot) by plotting the measurement data in the observation space using intensities of signals of two or more types of light as parameters. The region division unit 212 divides the observation space into a plurality of occupied regions based on the distribution of the measurement data in the observation space.

The gate candidate generation unit 213 inputs the feature value of each occupied region in the observation space to the machine learning model, and acquires a probability of a class to which each coordinate in the observation space belongs. The gate candidate generation unit 213 generates a gate candidate for each class based on the probability that the coordinate belongs to the class. The gate setting unit 214 sets a gate based on the gate candidate.

The analysis unit 215 executes analysis processing such as classification and counting of the measurement data based on the set gate.

In the present specification, an observation space using intensities of signals of two types of light as parameters will be described as an example.

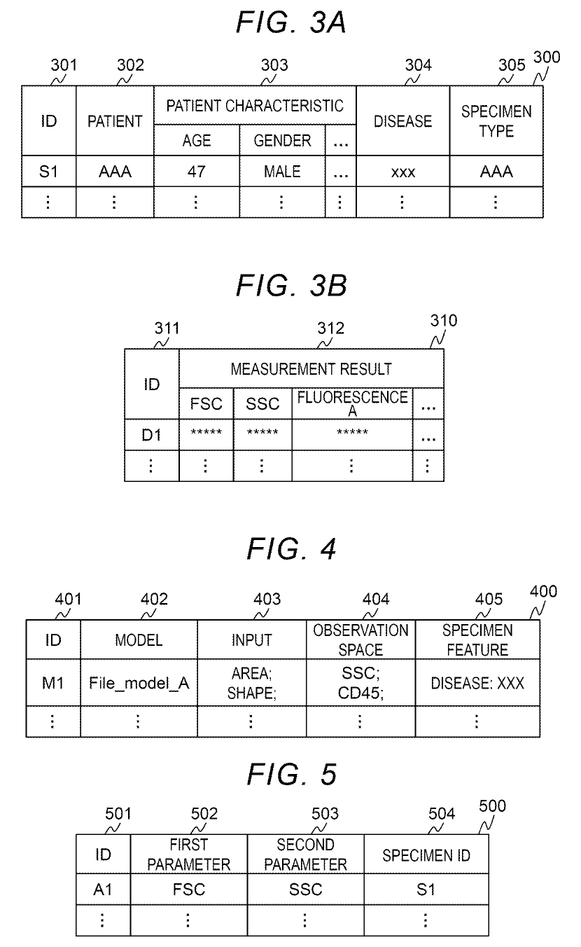

FIGS. 3A and 3B are diagrams illustrating examples of the measurement data database according to Embodiment 1.

The measurement data database stores a table 300 and a table 310.

The table 300 illustrated in FIG. 3A is a table for managing specimens. The table 310 illustrated in FIG. 3B is a table for managing the measurement data of a specimen. One table 310 corresponds to one measurement data set. In the table 310, an identification ID of the specimen is assigned.

The table 300 stores entries including an ID 301, a patient 302, a patient characteristic 303, a disease 304, and a specimen type 305.

The ID 301 is a field for storing the identification ID of the specimen. The patient 302 is a field for storing a name or the like for identifying the patient. The patient characteristic 303 is a group of fields for storing attributes representing characteristics of an individual patient, such as age and gender. The disease 304 is a field for storing a name or the like for identifying the disease. The specimen type 305 is a field for storing a type of the specimen. The specimen type 305 stores, for example, blood and bone marrow fluid.

The patient characteristic 303 may be managed by a table different from the table 300.

The table 310 stores entries including an ID 311 and a measurement result 312.

The ID 311 is a field for storing an identification ID of the measurement data. The measurement result 312 is a group of fields for storing the measurement result, that is, the measurement result of each measurement item of the particles. The measurement result 312 includes, for example, fields for storing signal intensities of forward scatter (FSC), side scatter (SSC), fluorescence of any wavelength, and the like. The invention is not limited to the type of light (measurement item) to be measured.

FIG. 4 is a diagram illustrating an example of the model database according to Embodiment 1.

The model database stores a table 400. The table 400 is a table for managing the machine learning model. The table 400 includes an ID 401, a model 402, an input 403, an observation space 404, and a specimen feature 405.

The ID 401 is a field for storing an identification ID of the machine learning model. The model 402 is a field for storing the machine learning model. The input 403 is a field for storing a type of the feature value of the occupied region input to the machine learning model. The observation space 404 is a field for storing parameters (measurement items) defining the observation space. The specimen feature 405 is a field for storing information on the feature of the specimen. The specimen feature 405 stores, for example, the type of disease.

The observation space 404 and the specimen feature 405 are fields used to select the machine learning model.

The entry may be provided with a field for storing information on a user who performs analysis. By managing the machine learning model for each user, it is possible to support the setting of a gate according to the purpose, characteristics, and the like of the user.

FIG. 5 is a diagram illustrating an example of the setting information database according to Embodiment 1.

The setting information database stores a table 500. The table 500 is a table for managing the analysis setting information. The table 500 stores entries including an ID 501, a first parameter 502, a second parameter 503, and a specimen ID 504.

The ID 501 is a field for storing an identification ID of the measurement data. The first parameter 502 and the second parameter 503 are fields for storing measurement items serving as parameters for defining the observation space. The specimen ID 504 is a field for storing an identification ID of the specimen.

FIG. 5 illustrates the analysis setting information that does not include information on characteristics of the specimen. When the information on the characteristics of the specimen is included, the entries of the table 500 include a field for storing the information.

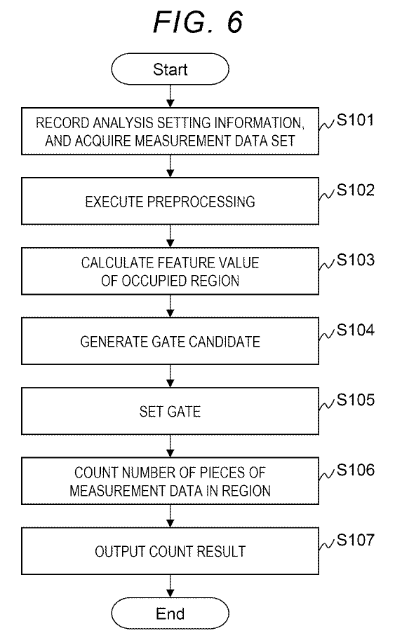

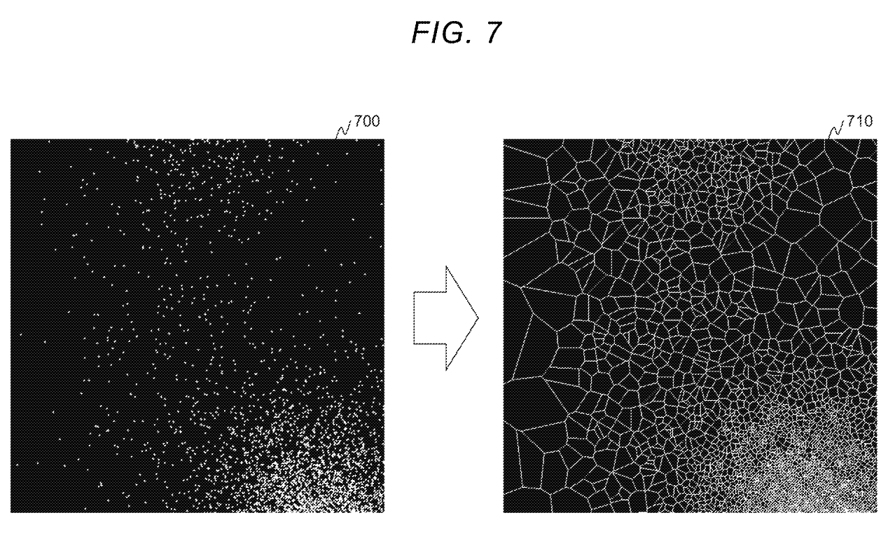

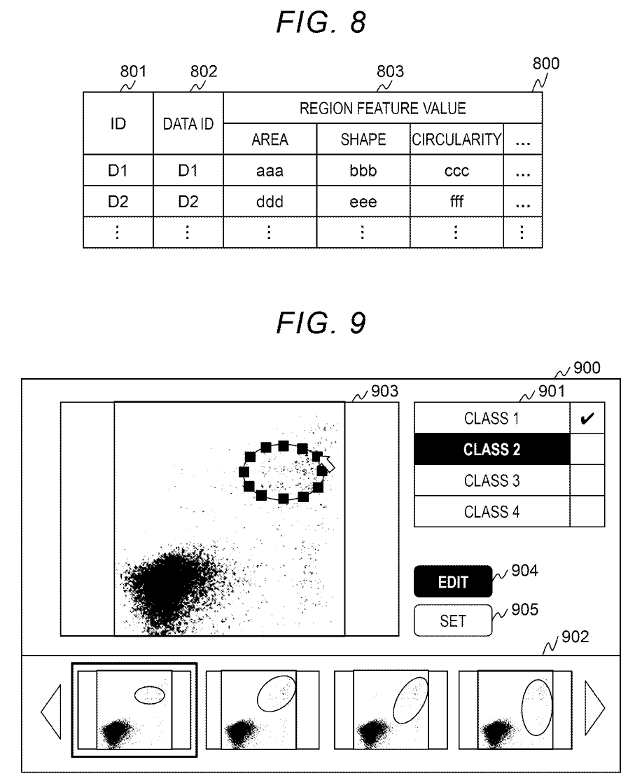

FIG. 6 is a flowchart illustrating an example of the analysis processing executed by the computer 100 according to Embodiment 1. FIG. 7 is a diagram illustrating an example of division of the observation space executed by the computer 100 according to Embodiment 1. FIG. 8 is a diagram illustrating an example of information stored by the computer 100 according to Embodiment 1. FIG. 9 is a diagram illustrating an example of a screen presented by the computer 100 according to Embodiment 1.

The user who analyzes the measurement data inputs an analysis request including the identification ID of the specimen and the analysis setting information via the input unit 202 of the computer 100.

The storage unit 204 registers the input analysis setting information in the setting information database, and acquires the measurement data set of the designated specimen from the measurement data database (step S101).

When acquiring the measurement data set, the storage unit 204 refers to the table 300 and acquires the entry in which the identification ID of the specimen designated in the ID 301 is set. The storage unit 204 acquires the table 310 to which the identification ID of the designated specimen is assigned.

The storage unit 204 inputs the analysis setting information and the measurement data set to the information processing unit 200. The control unit 210 of the information processing unit 200 inputs the measurement data set to the preprocessing unit 211, and inputs the analysis setting information to the region division unit 212 and the gate candidate generation unit 213.

The preprocessing unit 211 of the information processing unit 200 executes preprocessing on the measurement data set (step S102). The preprocessing unit 211 inputs the measurement data set subjected to the preprocessing to the region division unit 212.

The region division unit 212 of the information processing unit 200 calculates the feature value of the occupied region based on the measurement data set and the analysis setting information (step S103). Specifically, the following processing is executed.

(S103-1) The region division unit 212 sets the observation space based on the analysis setting information. The region division unit 212 generates a scatter diagram (dot plot) by plotting the measurement data in the observation space.

(S103-2) The region division unit 212 divides the observation space into a plurality of occupied regions based on the distribution feature of the measurement data in the observation space. For example, as illustrated in FIG. 7, the region division unit 212 divides the observation space into the plurality of occupied regions based on the Voronoi tessellation method. The measurement data is a generating point of the Voronoi tessellation. FIG. 7 illustrates a Voronoi diagram 710 obtained by dividing a scatter diagram 700 by the Voronoi tessellation method. A Voronoi diagram 710 is a division result.

(S103-3) The region division unit 212 calculates a feature value of each occupied region. For example, an area, a shape, a circularity, or the like is calculated as the feature value of the occupied region.

(S103-4) The region division unit 212 instructs the storage unit 204 to record the feature value of each occupied region. The storage unit 204 generates a table 800 having a data structure as illustrated in FIG. 8, and adds as many entries as the number of occupied regions. The storage unit 204 sets the identification ID of the measurement data in an ID 801 of each entry. The storage unit 204 sets the identification ID of the measurement data corresponding to a button included in the occupied region in a data ID 802 of each entry, and sets the feature value of the occupied region corresponding to the measurement data in a region feature value 804 of each entry.

(S103-5) The region division unit 212 outputs the scatter diagram, the Voronoi diagram (division result), and the table 800 to the gate candidate generation unit 213.

The above is a description of the processing in step S103. A method other than the Voronoi tessellation may be used to divide the observation space. For example, a division method using the results of maximum likelihood estimation using an adaptive kernel according to the shape of the distribution can be considered.

The gate candidate generation unit 213 of the information processing unit 200 generates the gate candidate using the feature value of the occupied region (step S104). Specifically, the following processing is executed.

(S104-1) The gate candidate generation unit 213 acquires information on the parameter for defining the observation space included in the analysis setting information. The gate candidate generation unit 213 refers to the table 400 stored in the model database and searches for an entry in which the acquired parameter is set in the observation space 404. When the analysis setting information includes a feature of the specimen, the item is also considered.

(S104-2) The gate candidate generation unit 213 acquires the machine learning model from the model 402 of the found entry.

When there are a plurality of corresponding entries, the gate candidate generation unit 213 may present selectable machine learning models via the output unit 203 to allow the user to select one. The gate candidate generation unit 213 may perform selection at random, or may perform selection based on a predetermined selection rule.

(S104-3) The gate candidate generation unit 213 inputs the feature value of the occupied region to the machine learning model according to the type of the feature value of the occupied region set in the input 403 of the found entry.

(S104-4) The gate candidate generation unit 213 specifies classes based on the output of the machine learning model and selects one class from the specified classes.

(S104-5) The gate candidate generation unit 213 sets a threshold. In the present embodiment, it is assumed that a list in which thresholds are set is registered in advance. The gate candidate generation unit 213 selects one threshold from the list.

(S104-6) For the selected class, the gate candidate generation unit 213 generates, as the gate candidate, a boundary of a region formed by coordinate points having a probability equal to or larger than the threshold based on the output of the machine learning model. Specifically, the gate candidate generation unit 213 records data in which coordinates of the boundary serving as the gate candidate are associated with the threshold and the class.

When there are a plurality of regions formed by coordinate points having probabilities equal to or larger than the threshold, a plurality of gate candidates are generated.

(S104-7) The gate candidate generation unit 213 determines whether the processing is completed for all the thresholds registered in the list. If the processing is not completed for all the thresholds registered in the list, the gate candidate generation unit 213 returns to S104-5. If the processing is completed for all the thresholds registered in the list, the gate candidate generation unit 213 proceeds to S104-8.

(S104-8) The gate candidate generation unit 213 determines whether the processing is completed for all the classes. If the processing is not completed for all the classes, the gate candidate generation unit 213 returns to S104-4. If the processing is completed for all the classes, the gate candidate generation unit 213 proceeds to S104-9.

(S104-9) The gate candidate generation unit 213 outputs the scatter diagram and the gate candidates of each class to the gate setting unit 214.

The above is a description of the processing in step S104. Loop processing of the class and loop processing of the threshold can be interchanged.

The gate setting unit 214 sets the gate based on the gate candidate (step S105). Specifically, the following processing is executed.

(S105-1) The gate setting unit 214 displays a screen 900 via the output unit 203.

Here, the screen 900 will be described. The screen 900 includes selection fields 901 and 902, a display field 903, and buttons 904 and 905.

The selection field 901 is a field for selecting a class. The selection field 901 displays selectable classes. A symbol indicating that processing is completed is displayed in a class in which the gate is set. The selection field 902 is a field for selecting a gate candidate of the class selected in the selection field 901. The display field 903 is a field for enlarging and displaying the gate candidate selected in the selection field 902.

(S105-2) When the user selects the class displayed in the selection field 901, the gate setting unit 124 displays the gate candidates of the selected class in the selection field 902. In FIG. 9, a boundary of an ellipse represents the gate candidate.

(S105-3) When the user selects the gate candidate displayed in the selection field 902, the gate setting unit 124 enlarges and displays the selected gate candidate in the display field 903. When there is a class in which a gate is set, the gate setting unit 124 may superimpose and display the gate of the class in the display field 903.

When correcting the gate candidate, the user operates the button 904 to correct the gate candidate displayed in the display field 903. When the gate candidate displayed in the display field 903 is set as the gate, the user operates the button 905.

(S105-4) When the setting of the gate is completed for all the classes, the gate setting unit 214 displays a screen for confirming whether the setting of the gate is completed via the output unit 203. When the setting of the gate is completed, the gate setting unit 214 outputs the scatter diagram and the gate to the analysis unit 215.

The above is a description of the processing in step S105.

The analysis unit 215 counts the number of pieces of measurement data in the region formed by the set gate (step S106), and outputs a count result via the output unit 203 (step S107).

Only one threshold may be set. In this case, the gate candidate is set as the gate directly. The analysis unit 215 may perform analysis for estimating a remaining state of the lesion based on the number of pieces of measurement data in a predetermined region.

As described above, the computer 100 generates the gate candidate using the feature value of the occupied region obtained by dividing the observation space based on the distribution feature of the measurement data in the observation space. Unlike the clustering method in the related art, this method does not focus only on the density of the measurement data, and may generate the gate candidate even in a space in which the measurement data is sparse. In addition, the user can quickly and easily set a desired gate by correcting the presented gate candidates as necessary and selecting one gate candidate from the presented gate candidates.

### Embodiment 2

Embodiment 2 is different from Embodiment 1 in that the computer 100 trains the machine learning model using a gate setting result. Hereinafter, Embodiment 2 will be described focusing on a difference from Embodiment 1.

A system configuration according to Embodiment 2 is the same as that in Embodiment 1. A hardware structure of the computer 100 according to Embodiment 2 is the same as that in Embodiment 1.

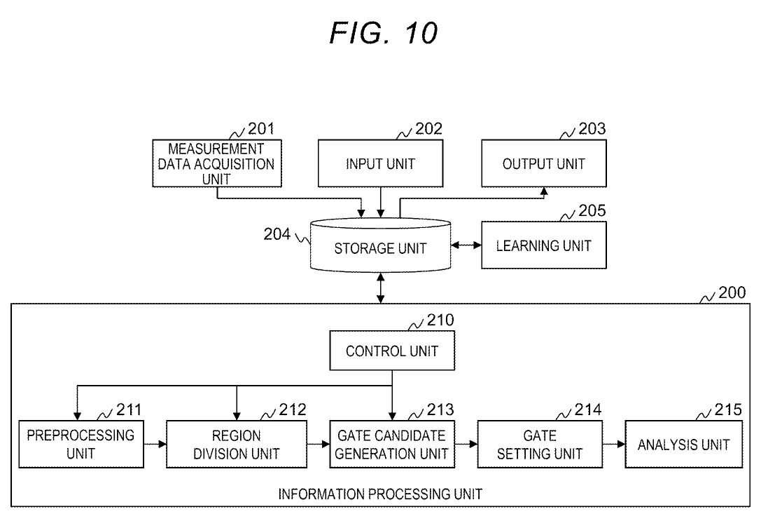

Embodiment 2 is different from Embodiment 1 in a functional configuration of the computer 100. FIG. 10 is a diagram illustrating an example of the functional configuration of the computer 100 according to Embodiment 2. The computer 100 according to Embodiment 2 newly includes a learning unit 205. In addition, the storage unit 204 according to Embodiment 2 is different from that in Embodiment 1 in that a gate database that stores the gate setting result is managed.

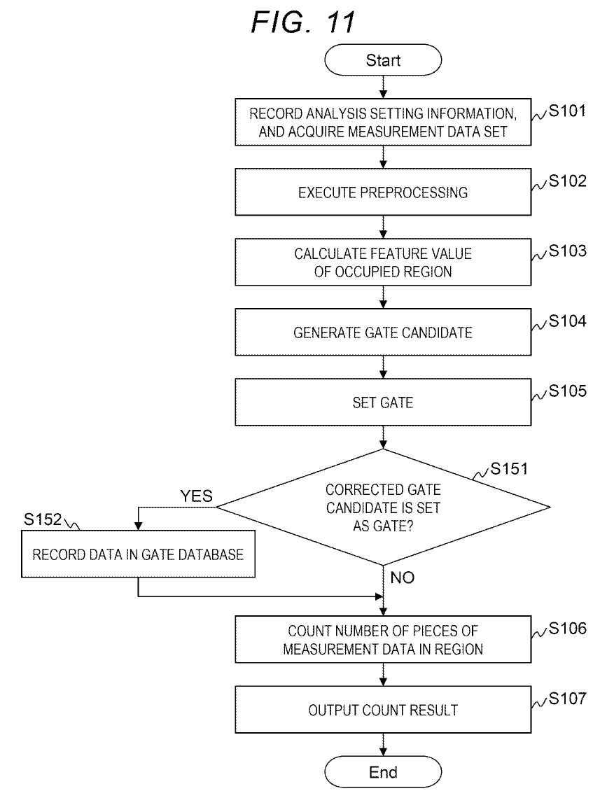

FIG. 11 is a flowchart illustrating an example of analysis processing executed by the computer 100 according to Embodiment 2.

After the processing in step S105, the gate setting unit 214 determines whether the gate candidate corrected by the user is set as the gate for at least one class (step S151).

If the gate candidate corrected by the user is not set as the gate, the computer 100 proceeds to step S106.

If the gate candidate corrected by the user is set as the gate for at least one class, the gate setting unit 214 records data in which the identification ID of the model, the table 800, and the gate are associated with one another in the gate database (step S152). Then, the computer 100 proceeds to step S106.

The computer 100 may execute the processing in step S152 without performing the processing in step S151, and then proceed to step S106.

The learning unit 205 executes learning processing when data is recorded in the gate database or periodically. The learning unit 205 trains the machine learning model using the data stored in the gate database. A training method is not limited.

According to Embodiment 2, the accuracy of the machine learning model can be improved by continuous learning.

The invention is not limited to the embodiments described above, and includes various modifications. For example, the embodiments described above are described in detail to facilitate understanding of the invention, and the invention is not necessarily limited to those including all the described configurations. A part of a configuration in each embodiment may be added to, deleted from, or replaced with another configuration.

A part or all of the configurations, functions, processing units, processing methods, and the like described above may be implemented by hardware by, for example, designing with an integrated circuit. The invention can also be implemented by a program code of software for implementing functions of the embodiments. In this case, a storage medium storing the program code is provided to a computer, and a processor provided in the computer reads the program code stored in the storage medium. In this case, the program code read from the storage medium implements the functions of the embodiments described above by itself, and the program code itself and the storage medium storing the program code constitute the invention. Examples of the storage medium for supplying such a program code include a flexible disk, a CD-ROM, a DVD-ROM, a hard disk, a solid state drive (SSD), an optical disk, a magneto-optical disk, a CD-R, a magnetic tape, a non-volatile memory card, and a ROM.

Further, the program code for implementing the functions described in the present embodiment can be implemented in a wide range of programs or script languages such as Assembler, C/C++, Perl, Shell, PHP, Python, and Java (registered trademark).

Further, the program code of the software for implementing the functions in the embodiments may be distributed via a network to be stored in a storage unit such as a hard disk or a memory of a computer or a storage medium such as a CD-RW or a CD-R, and a processor provided in the computer may read and execute the program code stored in the storage unit or the storage medium.

Control lines and information lines considered to be necessary for description are shown in the embodiments described above, and not all control lines and information lines in a product are necessarily shown. All the configurations may be connected.

What is claimed is:

1. A computer system comprising:
a processor; and
a storage device connected to the processor, wherein
the storage device stores
a data set constituted with measurement data including measurement results of intensities of a plurality types of signals of particles contained in a sample measured using a flow cytometry, and
a machine learning model configured to receive, as an input, a feature value of a first region generated by dividing an observation space using intensities of two or more types of signals as parameters based on a distribution feature of the measurement data in the observation space, and configured to output a probability of a class to which each coordinate of the observation space belongs, and
the processor
maps a plurality of pieces of the measurement data into an observation space using an intensity of a signal of a type selected by a user,
divides the observation space into a plurality of the first regions based on the distribution feature of the measurement data in the observation space,
calculates the feature value of each of the plurality of first regions,
inputs the feature value of each of the plurality of first regions into the machine learning model, and
sets a gate based on the probability of the class to which each coordinate in the observation space belongs, which is output from the machine learning model.

2. The computer system according to claim 1, wherein
the processor
repeatedly executes processing of setting a threshold and processing of generating, for each class, a boundary of a second region implemented by the coordinate in which the probability is larger than the threshold as a gate candidate based on the probability of the class to which each coordinate in the observation space belongs, which is output from the machine learning model,
presents an interface for the user to select, as the gate for each class, one gate candidate from among a plurality of the gate candidates of the class, and
sets the gate for each class based on an input from the user received via the interface.

3. The computer system according to claim 2, wherein
the processor sets, as the gate, the gate candidate corrected by the user and received via the interface.

4. The computer system according to claim 3, wherein
the processor
stores data in which the feature value of the first region and the gate candidate corrected by the user are associated with each other in a storage device, and
executes learning processing of the machine learning model using the data.

5. The computer system according to claim 1, wherein
the processor divides the observation space into the plurality of first regions based on a Voronoi tessellation method.

6. The computer system according to claim 1, wherein
the processor
counts the number of pieces of the measurement data included in a third region implemented by the gate, and
outputs a result of the counting.

7. The computer system according to claim 1, wherein
a plurality of the machine learning models are stored,
the machine learning model is managed in association with a type of the parameter defining the observation space and a type of the sample, and
the processor selects the machine learning model to be used based on the type of the parameter defining the observation space and the type of the sample.

8. An information processing method executed by a computer system, the computer system including a processor and a storage device connected to the processor,
the storage device storing
a data set constituted with measurement data including measurement results of intensities of a plurality types of signals of a plurality of particles contained in a sample measured using a flow cytometry, and
a machine learning model configured to receive, as an input, a feature value of a first region generated by dividing an observation space using intensities of two or more types of signals as parameters based on a distribution feature of the measurement data in the observation space, and configured to output a probability of a class to which each coordinate of the observation space belongs,
the information processing method comprising:
mapping, by the processor, a plurality of pieces of the measurement data into an observation space using an intensity of a signal of a type selected by a user;
dividing, by the processor, the observation space into a plurality of the first regions based on the distribution feature of the measurement data in the observation space;
calculating, by the processor, the feature value of each of the plurality of first regions;
inputting, by the processor, the feature value of each of the plurality of first regions into the machine learning model; and
setting, by the processor, a gate based on the probability of the class to which each coordinate in the observation space belongs, which is output from the machine learning model.

9. A non-transitory computer-readable storage medium storing a program to be executed by a computer,
the computer storing
a data set constituted with measurement data including measurement results of intensities of a plurality types of signals of a plurality of particles contained in a sample measured using a flow cytometry, and
a machine learning model configured to receive, as an input, a feature value of a first region generated by dividing an observation space using intensities of two or more types of signals as parameters based on a distribution feature of the measurement data in the observation space, and configured to output a probability of a class to which each coordinate of the observation space belongs,
the program causing the computer to execute operations comprising:
mapping a plurality of pieces of the measurement data into an observation space using an intensity of a signal of a type selected by a user;
dividing the observation space into a plurality of the first regions based on the distribution feature of the measurement data in the observation space;
calculating the feature value of each of the plurality of first regions;
inputting the feature value of each of the plurality of first regions into the machine learning model; and
setting a gate based on the probability of the class to which each coordinate in the observation space belongs, which is output from the machine learning model.
